(19) United States
(12) Patent Application Publication
(10) Pub. No.: US 2005/0183301 A1
(43) Pub. Date: Aug. 25, 2005

(54) Multi-picture louvered advertising sign apparatus and method

(76) Inventor: Oleg Zukov, Tzoran (IL)

Correspondence Address: Edward Langer;Shiboleth Yisraeli Roberts Zisman & Company, 60th Floor, 350 Fifth Avenue, New York, NY, 10118, US

(21) Appl. No.: 10/512,044

(22) PCT Filed:
(86) PCT No.: PCT/IL03/00329

Related U.S. Application Data
(60) Provisional application No. 60/374,204, filed on Apr. 22, 2002.

(51) Int. Cl. G09F 11/02; G09F 11/30

(52) U.S. Cl. 40/475; 40/511

(57) ABSTRACT

A multi-picture louvered advertising sign (10), using sign louvers (16) that move around individual tracks (14) in electromechanical synchronization. The synchronization mechanism utilizes sensors and a transmission mechanism that operates in response to control commands, such that the louvers come into an exposed position, at which point they temporarily rest, providing the required display. In sequential fashion, other louvers on the track are moved into the exposed position, so that the display is constantly updated. In a typical construction, each track has twenty louvers, with the faces of the louvers oriented generally perpendicular to the track that they traverse. Thus, per the louver mounting orientation of the present invention, an increase may be achieved over the prior art in the number of pictures that can be displayed. A recurring sequence may present animation of a set of still images.

### FIELD OF THE INVENTION

The present invention relates to mechanized advertising signs, and more particularly to a multi-picture louvered advertising sign, featuring sign louvers that are moved around individual tracks in electromechanical synchronization.

### BACKGROUND OF THE INVENTION

The prior art of advertising sign exhibiting, is almost exclusively based on use of a plurality of triangular shaped members, rotatably mounted in a frame. These triangular shaped members are commonly referred to as prisms. As described in U.S. Pat. No. 4,189,859 to Ahlgren (1980), each of the prisms includes adjacent longitudinally extending side surfaces so that each set of associated side surfaces of the prisms provides a display when rotated to a side by side position. Thus the number of side surfaces defines a recurring display sequence. Each prism is provided with a pair of rotation axles disposed at opposite ends of the prism. A drive motor and a transmission rotate the prisms synchronously, the drive motor being connected to one of the rotation axles.

Examples of such designs for devices employing triangular shaped members may be found in U.S. Pat. No. 3,921,321 to Weisskopf (1975), U.S. Pat. No. 4,528,763 to Ahlgren (1985), U.S. Pat. No. 5,003,716 to Dyar (1991), U.S. Pat. No. 5,255,465 to Perez (1993), U.S. Pat. No. 5,416,996 to Clemens et al (1995), and U.S. Pat. No. 5,572,816 to Anderson, Jr. et al (1996).

From the above survey it is apparent that within a time-frame of twenty one years, 1975-1996, there exists an almost total dependence on and usage of the triangular members as the basis for louvered advertising signs.

In U.S. Pat. No. 3,826,027 to Abbema (1974), the inadequacies of the prisms are described as including:
The display of three different advertising panels per prism does not adequately cope with the problem of limited outdoor advertising space.
To convey an advertising message well generally requires more than three different pictures per advertising unit and consequently several prisms are used mounted side by side. The need to use many units per advertisement makes the prism solution expensive and as a result, their use has generally been limited to prime outdoor locations where they are constantly visible to the public.
The tri-faced sign has made few inroads on the indoor advertising market, as well, since it is an expensive solution.

Simple arithmetic indicates that in order to display almost any but the simplest advertisements, a large number of adjacent units must be used. This translates into inefficient use of limited outdoor advertising space, or of expensive indoor advertising space.

Abbema '027 discloses a display sign which employs a plurality of endless loops, upon which are mounted adjacently to one another a plurality of planar elements, with the loop rotating to successively present, with precision, numerous advertising images for a brief period of time.

The Abbema device appears to be quite cumbersome, and it is highly likely that the added cost of many additional device elements, such as the endless loop conveying apparatus, and additional connector means would seem to make the Abbema solution both expensive and complex.

A review of the deficiencies of the prior art exposed a need for a multi-picture louvered advertising sign, which would:
Enable displaying a much larger number of different pictures per advertising unit.
Result in a large reduction in the number of adjacent advertising units required to convey a slightly complex advertising message.
Result in a large saving in the expenditure required to build, set-up and maintain a large number of adjacent advertising units, as had been required by the prior art.
Result in a substantial reduction in the inefficient use of limited outdoor advertising space.
Make it economically feasible to use louvered advertising signs for indoor advertising space.

Therefore, it would be desirable to provide an advertising sign, simple in design and operation, having the capability of displaying a large number of pictures at minimum cost and space requirement.

### SUMMARY OF THE INVENTION

Accordingly, it is a principal object of the present invention to overcome the above-mentioned disadvantages and provide a multi-picture louvered advertising sign, using sign louvers that move around individual tracks in electromechanical synchronization. The synchronization mechanism utilizes sensors and a transmission mechanism that operates in response to control commands. The electromechanical synchronization is such that the louvers come into an exposed position, at which point they temporarily rest, providing the required display. In sequential fashion, other louvers on the track are moved into the exposed position, so that the display is constantly updated.

In accordance with a preferred embodiment of the present invention, there is provided a multi-picture louvered advertising sign apparatus comprising:
a frame having a plurality of individual tracks;
a plurality of louvers mounted so as to move along an associated one of the tracks in the frame, each of the louvers having a pair of longitudinally extending side surfaces, each providing a display portion; and
transmission means for moving the louvers on each of said associated tracks synchronously,
each of the louvers being mounted so as to be oriented perpendicularly to its associated track, such that when moved by the transmission means into a display position, the side surfaces of the louvers define a recurring sequence of the display portions presenting a multiple number of advertising pictures.

In a typical construction, each track has twenty louvers, with the faces of the louvers oriented generally perpendicular to the track that they traverse. This is in sharp contrast to the approach taken by the prior art Abbema patent (see Background), in which the planar elements are oriented with their faces positioned parallel to the circuit or track that they traverse. A simple analogy would be to compare the packing of dominoes standing side-by-side to dominoes arranged face to back. Clearly, many more dominoes can be packed into the same given space when employing the face-to-back orientation. Thus, per the louver mounting orientation of the present invention, an increase may be achieved in the number of pictures that can be displayed, from nine pictures per Abbema, to twenty pictures per the present invention.

Each track enables motion of the louvers at a speed that enables exchanging or replacing individual louvers at a rate of 2 louvers per second, thereby displaying twenty different pictures using a slightly slower rate than that used in film speed, but still a high enough rate to allow for the eye to integrate the motion and make it a smooth one for purposes of conveying motion of the object, displayed in the advertisement.

Yet another important feature of this design enables a section of louvers on different tracks to be controlled at a speed that is different than the other louvers of other tracks so that a section of the advertisement can be dedicated to a slower exchange rate of louvers. This enables a portion of the multi-image advertising display to have what is called dynamic movement and a portion of the advertising display to have static display of various pictures.

Other features and advantages of the invention will become apparent from the drawings and the description contained hereinbelow.

### BRIEF DESCRIPTION OF DRAWINGS

For a better understanding of the invention, with regard to the embodiments described, reference is made to the accompanying drawings, in which like numbers designate corresponding elements or sections throughout, and in which:

FIG. 1 shows an overall perspective view of a preferred embodiment of the multi-picture louvered advertising sign apparatus, constructed and operated, in accordance with the principles of the present invention;

FIG. 2 shows a cross-sectional view of the apparatus of FIG. 1, showing louvers mounted in a frame;

FIG. 3 shows a front view of the apparatus of FIG. 1, showing transmission means for rotation of louvers;

FIG. 4 shows a top view of a preferred embodiment of the apparatus of FIG. 1, showing a plurality of louvers mounted in a plurality of tracks, with the transmission provided via a driving gear mounted so as to internally engage the chain loop of the track at its curved end portion;

FIGS. 5a-c show, respectively, top and enlarged detailed views of an alternate embodiment of the apparatus of FIG. 1, showing a plurality of louvers mounted in a plurality of tracks, with the transmission provided via a driving gear mounted so as to externally engage the chain loop of the track;

FIG. 6 shows an electronic schematic diagram of a transmission controller;

FIG. 7 shows a front view of the apparatus of FIG. 4, including a detailed view of the transmission means;

FIG. 8 shows a front view of the apparatus of FIG. 5, including a detailed view of the transmission means;

FIG. 9 shows an enlarged view of the transmission means of FIG. 8, including a detailed view of the control sensor; and

FIG. 10 shows a top view of an alternate embodiment of the apparatus of FIG. 1, in which the louvers have been mounted one on every two links, thereby allowing presentation of more pictures per track of given dimensions.

### DETAILED DESCRIPTION OF A PREFERRED EMBODIMENT

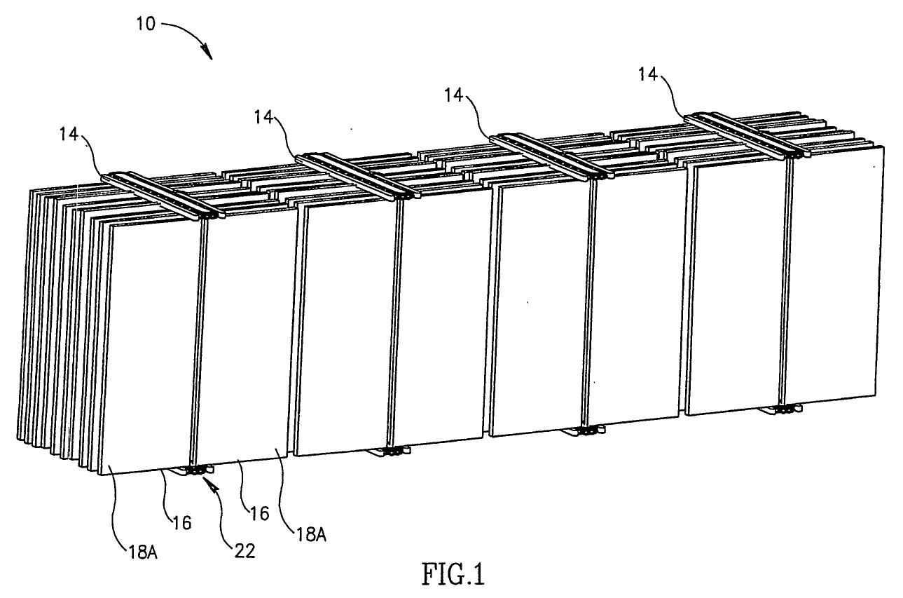

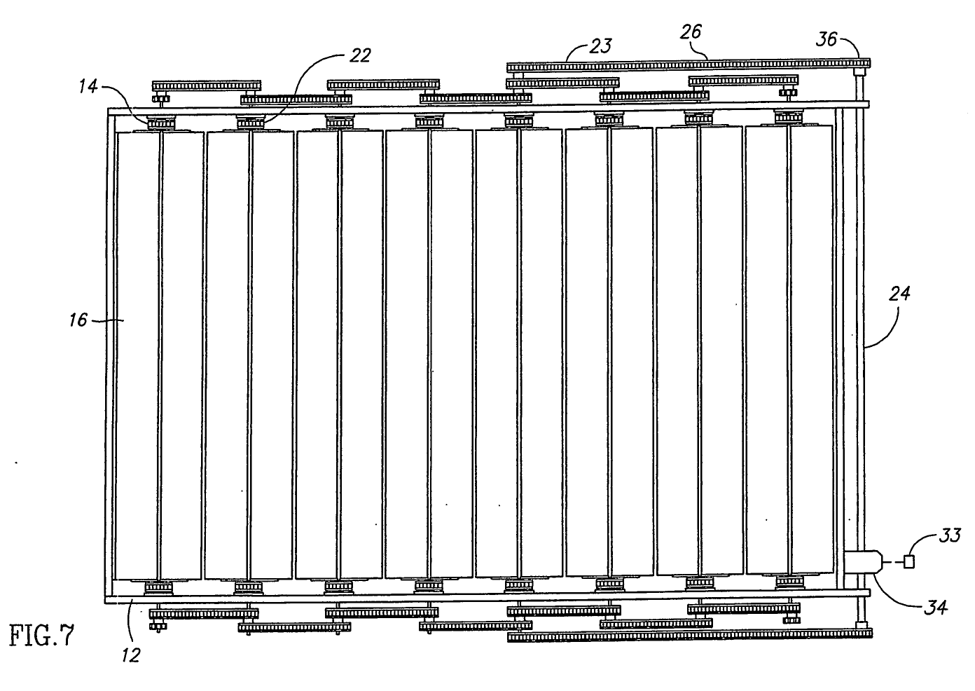

Referring to FIG. 1, there is shown an overall perspective view of a multi-picture louvered advertising sign apparatus 10 comprising a frame 12 (see FIG. 7) having a plurality of individual tracks 14, each track 14 comprising a chain loop, to which are mounted a plurality of louvers 16. The faces of the louvers 16 are oriented generally perpendicular to the track 14 that they traverse. Each of the louvers 16 has a pair of longitudinally extending side surfaces 18a, 18b, each providing a display portion. The advertising display can be pasted as a complete advertising “panel” onto these side surfaces 18a-b on all the tracks at once, and then slits between the portions of the display can be formed by slitting the advertising panel between the louvers 16.

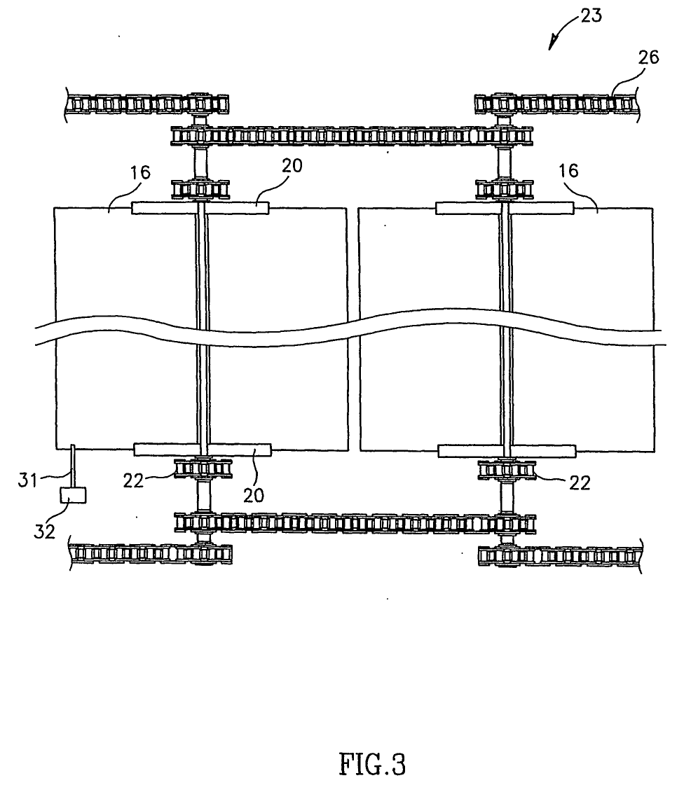

Each of the louvers 16 is attached to a corresponding support base 20 (see FIG. 3), which in turn is mounted on its associated track 14. The transmission is provided via a driving gear 22, mounted so as to internally engage the chain loop of track 14 at its curved end portion. Gear 22 is rotated by a transmission means (see FIGS. 3, 7), and in turn transmits motion via track 14 to the support bases 20 and to the louvers 16, which are attached thereon, so that they travel as track 14 moves around.

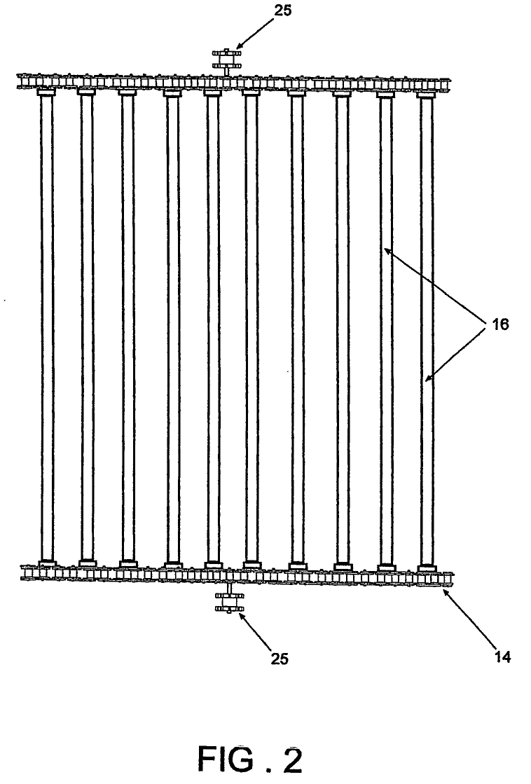

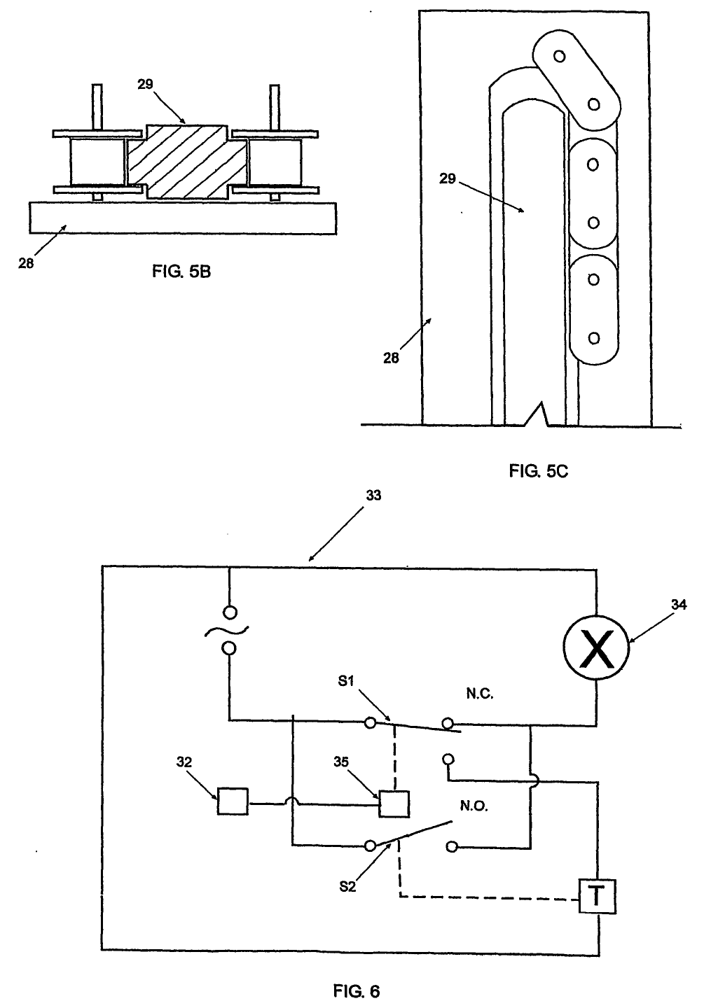

In FIG. 2, there is shown a cross-sectional view of the apparatus 10 of FIG. 1, showing louvers 16 mounted in a frame 12 (see FIG. 7). In this alternate embodiment, driving gear 22 is not shown, but it is mounted on the same shaft as a transmission gear 25, and gear 22 is arranged so as to externally engage the chain loop of track 14 (see FIG. 5), to transmit motion to track 14 and to the associated louvers 16.

FIG. 3 is a front view of the apparatus of FIG. 1, showing transmission means 23 for rotation of louvers 16. Each of the louvers 16 is attached to a corresponding support base 20, which in turn is connected to its associated track 14. The chain loops of track 14 are shown positioned above and below the louvers 16. Connecting the ends of the louvers to the support bases 20 mounted on the tracks 14, one at the top of the louver 16 and the other at its bottom, ensures maximum synchronization of louver 16 movement. Gear 22, mounted so as to internally engage the chain loop of track 14 at its curved end portion, is rotated by transmission means 23 via transmission chains 26, and in turn causes the louvers 16 to progress along the corresponding track 14.

A contact sensor 32 containing a micro-switch with an actuator 31, extends upward from the frame 12 positioned below the track 14, so as to come into contact with the lower edge of each of moving louvers 16. As described in connection with FIG. 6, contact sensor 32 determines the point at which the louvers 16 come to rest in the display position.

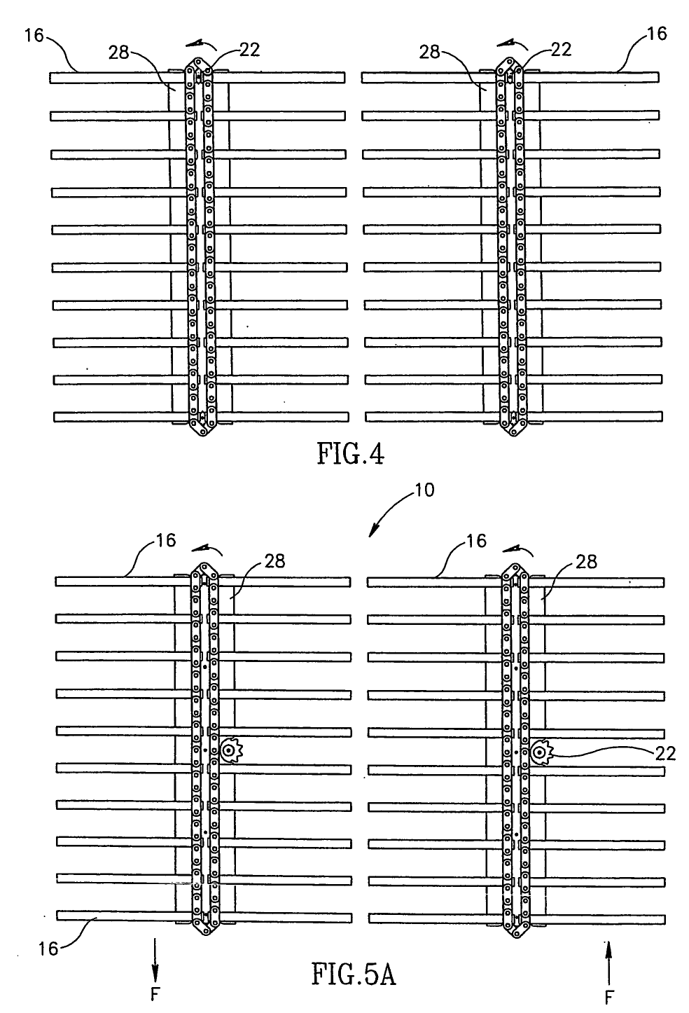

FIG. 4 shows a top view of an alternate embodiment of the apparatus of FIG. 1, showing a plurality of louvers 16 mounted in a plurality of tracks 14, with the transmission provided via a driving gear 22 mounted so as to internally engage the chain loop of the track 14 at its curved end portion. In this embodiment, the louvers are mounted one for every three links of the track 14 chain loop. The track 14 chain loop links ride on a track support shoe 28, typically of rigid smooth plastic, to provide sliding support.

FIG. 5a shows a top view of a preferred embodiment of the apparatus 10 of FIG. 1, showing a plurality of louvers 16 mounted in a plurality of tracks, with the transmission provided via a driving gear 22 mounted so as to externally engage the chain loop of the track 14. The arrows (“F”) show the direction of louver 16 motion.

FIGS. 5b-c show enlarged detail views of the track arrangement of FIG. 5a, with track 14 having a guide 29 on which the track chain loop links ride, on top of shoe 28.

Referring to FIG. 6, there is shown an electronic schematic diagram of a transmission controller 33. The synchronization between the moving louvers 16 and the louvers 16 to be exposed in the display position is achieved by use of a counter 35. This counter 35 is triggered by the contact sensor 32 and counts the louvers 16 as they pass by and touch the actuator 31 (see FIG. 3) of sensor 32. When a preset number of louvers 16 is reached by counter 35, a control command is given to the transmission mechanism via an opening motion of toggle switch S1 from its normally closed position, to stop the motor 34 and to reset and activate a timer T. The timer T setting defines how long the louvers 16 remain in the display position, before changing the display. This results in an exposed pair of louvers 16 and side surfaces 18a-b remaining temporarily stationary in the display position, for advertising purposes.

At the end of the specified display period, the timer T activates the motor 34 by, closing switch S2, providing power to motor 34, and when the next louver 16 passes the micro-switch of sensor 32, power to the timer T is cut off by re-setting counter 35, which recloses switch S1 in the normal position and reopens switch S2.

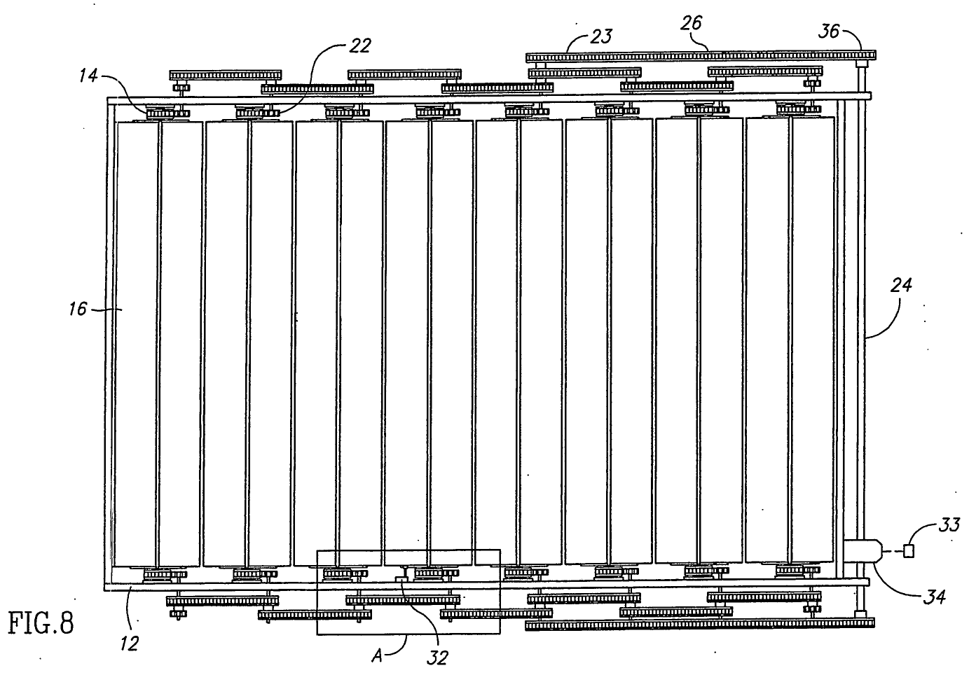

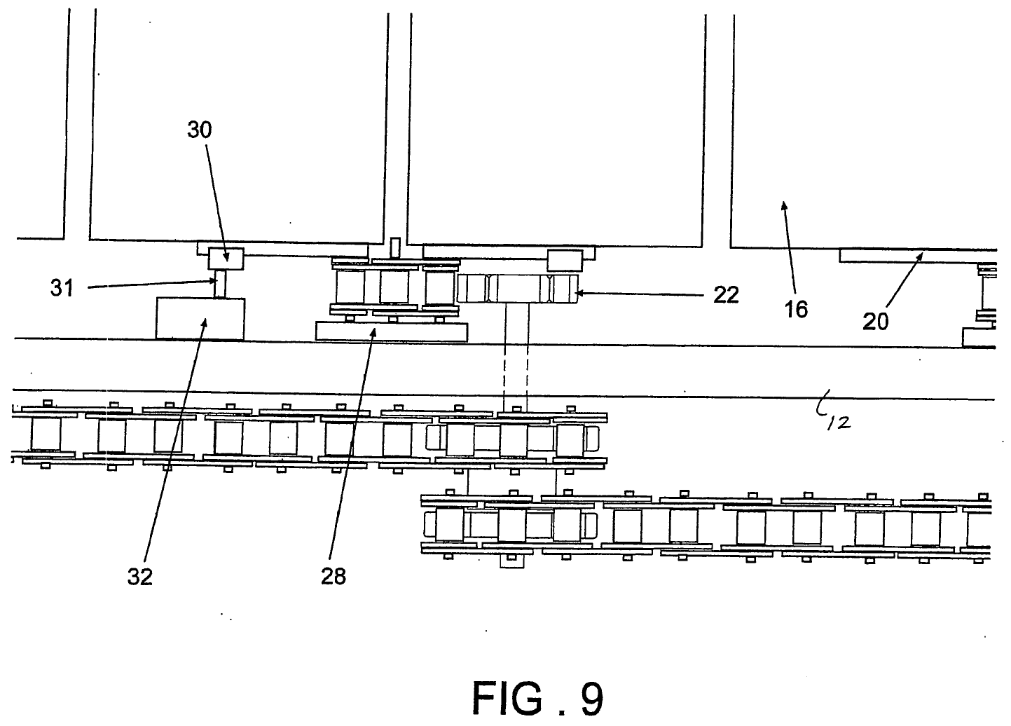

Alternately, a slidably adjustable pin 30 (see FIGS. 8-9) may be used instead of the counter 35. The pin 30 is mounted in slidably adjustable fashion on a lower edge of the louvers. The slidably adjustable pin 30 can be set on pre-selected louvers 16 to come into contact with the sensor 32. When the pin 30 is set, only the pre-selected louvers 16 contact the sensor 32 and this design makes for easy changing of the sequence by the installer of the advertising panels. Thus, by simple thumb adjustment of the pin 30—the sequence is defined.

FIG. 7 shows a front view of the apparatus of FIG. 4, including a detailed view of the transmission means 23, comprising motor 34, driver gears 36, and transmission chains 26. Controller 33 starts and stops motor 34, as described in the electronic schematic diagram of FIG. 6. Driver gears 36 are mounted on drive shaft 24. When the motor 34 is activated it transmits motion to the driver gears 36, which in turn transmit the motion in a synchronized manner to the gears 22 of each track 14, via the transmission chains 26.

FIG. 8 shows a front view of the apparatus of FIG. 5a, and FIG. 9 shows an enlarged view of FIG. 8, including a detailed view of the transmission means and the contact sensor 32 (inset “A”).

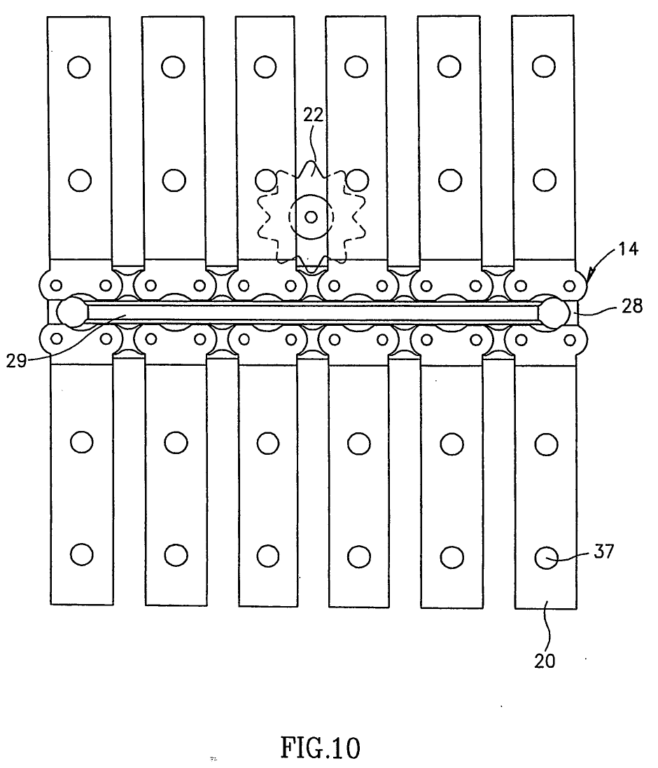

Referring to FIG. 10, there is shown a top view of an alternate embodiment of the apparatus of FIG. 1, in which one louver 16 and its associated support base 20 is mounted on every second link, thereby allowing presentation of more pictures per track of given dimensions. Optional louver mounting holes 37 are shown in base 20.

With appropriate mechanical design, the dimensions of frame 12, the number of tracks 14 and the number of louvers per track 14 can be established for a given advertising application, so that larger and smaller signs can be constructed as needed.

In operation, the multi-picture louvered advertising sign apparatus projects an effect of continuous movement of a display object to viewers. A recurring sequence may present animation of a set of still images. For example, the display may be arranged to show a car moving down a road, by the sequence of interleaved louvers which, when moving with a regular smooth motion, provide an effect of a continuous motion on the advertising display. The speed of the motor can be varied and therefore the rate of replacement of louvers and changing of pictures can also be controlled.

For example, a particular portion of the advertising sign associated with certain tracks 14 may be assigned a slower rotation speed and slower turnover of different pictures, whereas other louvers in another portion may have a more rapid turnover. Operation in this fashion presents an effect of different activities occurring on the same advertising sign, at different speeds. This allows for the sign to convey a given message in an integrated fashion. A recurring sequence may present an interactive picture using a set of still images.

This operation is for the enjoyment and entertainment of the viewer, who will then get the message of the advertisement in a particular fashion. This enables a multi-image advertising display in which a portion of the advertising display exhibits dynamic movement and a portion of the display exhibits a static arrangement of various pictures. This provides a display having an integration of dynamic and static information, enabling development of an impression by the viewer of moving pictures and static pictures. A recurring sequence may therefore present a developing message using a related set of still images. This can be exploited for many effects in advertisement and communication, for the benefit of conveying the message more effectively.

For example, in a developing message, a small image may be displayed which is superimposed on a larger image, and as the display continues to operate, the smaller image grows in size in subsequent images until it completely fills the display area. This same technique may be reversed, so that an image is reduced until it is replaced.

Having described the invention with regard to certain specific embodiments, it is to be understood that the description is not meant as a limitation since further modifications may now suggest themselves to those skilled in the art, and it is intended to cover such modifications, as fall within the scope of the appended claims.

1. A multi-picture louvered advertising sign apparatus comprising:
a frame having a plurality of individual tracks;
a plurality of louvers mounted so as to move along an associated one of said tracks in said frame, each of said louvers having a pair of longitudinally extending side surfaces, each providing a display portion; and
transmission means for moving said louvers along each of said associated tracks synchronously,
each of said louvers being mounted so as to be oriented perpendicularly to its associated track, such that when moved by said transmission means into a display position, said side surfaces of said louvers define a recurring sequence of said display portions presenting a multiple number of advertising pictures.

2. The apparatus of claim 1 wherein said recurring sequence is defined by the number of louvers which move on one of said associated tracks until said display position is reached.

3. The apparatus of claim 2 further comprising electromechanical means for determining said number of louvers which move on an associated track until said display position is reached.

4. The apparatus of claim 3 wherein said electromechanical means comprises a pin mounted in slidably adjustable fashion on a lower edge of said louver, which contacts a micro-switch during louver movement.

5. The apparatus of claim 1 wherein said recurring sequence is provided in accordance with a rate of motion of louvers per elapsed time.

6. The apparatus of claim 5 wherein said louver motion rate is between approximately 2-4 louvers per second.

7. The apparatus of claim 1 wherein said multiple number of pictures is related to said frame size.

8. The apparatus of claim 1 wherein said transmission means comprises a chain forming a loop which engages a driving gear mounted so as to internally engage the chain loop of the track at its curved end portion.

9. The apparatus of claim 1 wherein said transmission means comprises a chain forming a loop, which engages a driving gear mounted so as to externally engage the chain loop of the track along its length.

10. The apparatus of claim 1 wherein said recurring sequence presents animation of a set of still images.

11. The apparatus of claim 1 wherein said recurring sequence presents a developing message using a related set of still images.

12. The apparatus of claim 1 wherein said recurring sequence presents an interactive picture using a set of still images.

13. A method of presenting multi-picture louvered advertising comprising:
providing a frame having a plurality of individual tracks;
providing a plurality of louvers mounted so as to move along an associated one of said tracks in said frame, each of said louvers being mounted so as to be oriented perpendicularly to its associated track and having a pair of longitudinally extending side surfaces, each providing a display portion; and
moving said louvers along each of said associated tracks synchronously,
such that when moved into a display position, said side surfaces of said louvers define a recurring sequence of said display portions presenting a multiple number of advertising pictures.

14. The method of claim 13 wherein said recurring sequence is defined by the number of louvers which move on one of said associated tracks until said display position is reached.

15. The method of claim 14 wherein said number of louvers which move on an associated track until said display position is reached is predetermined.

16. The method of claim 13 wherein said recurring sequence is provided in accordance with a rate of motion of louvers per elapsed time.

17. The method of claim 16 wherein said louver motion rate is between approximately 2-4 louvers per second.

18. The method of claim 13 wherein said multiple number of pictures is related to said frame size.

19. The method of claim 13 wherein movement of said louvers is performed by a transmission means comprising a chain forming a loop which engages a driving gear mounted so as to internally engage said chain loop of the track at its curved end portion.

20. The method of claim 13 wherein movement of said louvers is performed by a transmission means comprising a chain forming a loop, which engages a driving gear mounted so as to externally engage said chain loop of the track along its length.

21. The method of claim 13 wherein said recurring sequence presents animation of a set of still images.

22. The method of claim 13 wherein said recurring sequence presents a developing message using a related set of still images.

23. The method of claim 13 wherein said recurring sequence presents an interactive picture using a set of still images.
